(19) United States
(12) Patent Application Publication
(10) Pub. No.: US 2018/0222583 A1
(43) Pub. Date: Aug. 9, 2018

(54) UAV Booster Aircraft for Takeoff and Climb Assist

(71) Applicant: Aurora Flight Sciences Corporation, Manassas, VA (US)

(72) Inventors: Robert W. Parks, San Jose, CA (US); Riley C. Griffin, Manassas, VA (US); Christopher Courtin, Manassas, VA (US); Amanda Kaufman, Manassas, VA (US); Thomas Clancy, Manassas, VA (US)

(21) Appl. No.: 15/890,506

(22) Filed: Feb. 7, 2018

Related U.S. Application Data
(60) Provisional application No. 62/456,021, filed on Feb. 7, 2017.

(51) Int. Cl. B64C 39/02; B64C 19/00

(52) U.S. Cl. CPC B64C 39/024; B64C 19/00; B64C 2201/021; B64C 2201/12; B64C 2201/141

(57) ABSTRACT

Disclosed herein is a booster aircraft system having a host aircraft and one or more booster UAVs coupled thereto. When necessary, such as during takeoff and climb of the host aircraft, the booster UAVs operate to boost the thrust of the host aircraft. The booster UAVs are configured to detach from the host aircraft when no longer needed (e.g., at cruising altitude/speed), thus removing their weight from the host aircraft. Each booster UAV includes wings, one or more propulsors, a control system, and landing gear, which enable the booster UAV to return autonomously to a predetermined location once detached from the host aircraft to be refueled and reused.

### CROSS-REFERENCE TO RELATED APPLICATION

The present application claims the benefit under 35 U.S.C. § 119(e) of U.S. Provisional Patent Application Ser. No. 62/456,021, filed Feb. 7, 2017 and titled “UAV Booster Aircraft for Takeoff and Climb Assist,” the contents of which are hereby incorporated by reference

### TECHNICAL FIELD

The present disclosure relates to the field of unmanned aerial vehicles (UAVs); more particularly, to UAVs to assist a host aircraft during takeoff and/or ascent phase of flight.

### BACKGROUND

Maintaining persistent monitoring of an area of interest is a key enabler for surveillance/reconnaissance operations, with which UAVs play a critical role. Without an onboard pilot, UAVs can loiter on-station to their full endurance and can provide constant surveillance of the area of interest; typically relaying information back to a remote location. Unfortunately, most current-generation UAVs have a maximum endurance of 20-40 hours, meaning that, to provide this constant time on station, multiple vehicles need to be deployed. Particularly in cases where the target is substantially far from the launching point, this necessitates multiple changeovers of aircraft in a short time period and presents the risk of gaps in coverage. There exists a need for a low-cost, ultra-long endurance aircraft that can provide on-station capability without imposing excessive logistical burdens.

A driving requirement for aircraft propulsion is the maximum power condition, which is typically needed during the takeoff and climb (i.e., ascent) portions of the flight envelope. For long-endurance UAVs, this means that the propulsion system must be sized to accommodate the thrust requirements during the takeoff/climb phase of flight; however, the vast majority of the operational time of the aircraft is spent at a very different and likely off-peak operating point (e.g., during a cruise phase of flight). If the vehicle propulsion system did not have to be sized to facilitate the takeoff/climb phase of flight, vehicle propulsion system could instead be optimized for the cruise phase of flight; thereby increasing the range and endurance of the UAV. Specifically, reducing the size of the propulsion system also reduces aircraft weight and unit cost.

Therefore, a need exists for a vehicle and a vehicle system capable of temporarily achieving the thrust requirements needed during the takeoff and climb phase of flight, but that is also optimized for the cruise condition, which does not require high power propulsion systems. In view of the foregoing, a need exists for a novel vehicle system that employs booster UAVs operable to assist a host aircraft when an increased/higher thrust is needed, e.g., during the takeoff and/or ascent phase of flight.

### SUMMARY

The present disclosure is directed to a booster UAV and UAV system configured to assist a host aircraft during takeoff and/or ascent portions of the flight envelope. The booster UAVs may be configured to affix to the host aircraft's frame or wings to allow the host aircraft to be optimally sized for a given operating condition, thereby providing increased thrust only when needed (i.e., during takeoff and/or ascent phase of flight). The booster UAVs may be configured to affix to an existing structure of the host aircraft, such as a pylon or a canard. When the increased thrust is no longer needed, e.g., the vehicle attains a certain altitude (e.g., a cruise altitude) and is ready to cruise, the booster UAVs may detach from the host aircraft's airframe and return to a base station or launch point (or another predetermined location) through gliding or via their own propulsion system(s). To that end, the booster UAVs may be configured to autonomously land so that they may refuel and be used to launch another host vehicle.

According to a first aspect, a booster unmanned aerial vehicle (UAV) configured to provide supplemental thrust to a host aircraft comprises: a propulsor; an airframe having at least one wing with a moveable flight control surface; an aircraft coupling attached to the airframe and configured to removably couple with the host aircraft; and a flight control system operatively coupled with the propulsor, the aircraft coupling and the moveable flight control surface, the flight control system being configured to autonomously navigate the booster UAV, wherein the flight control system is configured to: control the propulsor to provide supplemental thrust to the host aircraft during takeoff and ascent of the host aircraft; disengage the aircraft coupling to release the booster UAV from the host aircraft upon a trigger event; and control the moveable flight control surface to autonomously navigate the booster UAV to a predetermined location during descent.

In certain aspects, the booster UAV is reusable.

In certain aspects, the flight control system is in communication with an onboard sensor from the host aircraft.

In certain aspects, the propulsor employs jet propulsion and/or a motor-driven propeller.

In certain aspects, the propulsor employs an engine-driven propeller.

In certain aspects, the propulsor employs a rocket engine.

In certain aspects, the aircraft coupling comprises a pylon configured to engage a rail positioned on the host aircraft.

In certain aspects, the rail is positioned on a wing of the host aircraft.

In certain aspects, the flight control system is configured to control the propulsor to produce a desired amount of thrust during descent.

In certain aspects, the booster UAV is configured to glide to the predetermined location during descent.

In certain aspects, the flight control system is configured to disable the propulsor during descent.

In certain aspects, the flight control system is configured to idle the propulsor during descent.

In certain aspects, the booster UAV further comprises a second propulsor operatively coupled with the flight control system, wherein the flight control system is configured to control the second propulsor to produce a desired amount of thrust during descent. For example, the propulsor may employ jet propulsion or rocket propulsion and the second propulsor may employ a motor-driven propeller.

In certain aspects, the trigger event occurs when either of the host aircraft or the booster UAV achieves a predetermined altitude.

In certain aspects, the predetermined altitude is a cruise altitude for the host aircraft.

In certain aspects, the host aircraft comprises a propulsor configured to operate at an altitude range that ranges from a minimum altitude to a maximum altitude.

In certain aspects, the predetermined altitude is the minimum altitude.

According to a second aspect, a method for providing supplemental thrust to a host aircraft using a booster unmanned aerial vehicle (UAV) comprises: attaching the booster UAV to a host aircraft via an aircraft coupling, wherein the aircraft coupling is attached to an airframe of the booster UAV and is configured to removably couple with the host aircraft; controlling, via a flight control system, a propulsor of the booster UAV to provide supplemental thrust to the host aircraft during takeoff and ascent of the host aircraft; disengaging the aircraft coupling to release the booster UAV from the host aircraft upon a trigger event; and autonomously navigating, via a flight control system, the booster UAV to a predetermined location during descent.

In certain aspects, the booster UAV is reusable.

In certain aspects, the propulsor employs jet propulsion.

In certain aspects, the propulsor employs a motor-driven propeller.

In certain aspects, the propulsor employs an engine-driven propeller.

In certain aspects, the propulsor employs a rocket engine.

In certain aspects, the aircraft coupling comprises a pylon configured to engage a rail positioned on the host aircraft.

In certain aspects, the rail is positioned on a wing of the host aircraft.

In certain aspects, the method further comprises the step of controlling the propulsor to produce a desired amount of thrust during descent.

In certain aspects, the step of controlling the propulsor further comprises: receiving, with the flight control system, an onboard sensor input from the host aircraft; and controlling the propulsor based on the onboard sensor input.

In certain aspects, the booster UAV is configured to glide to the predetermined location during descent.

In certain aspects, the method further comprises the step of disabling the propulsor during descent.

In certain aspects, the method further comprises the step of disabling idling the propulsor during descent.

In certain aspects, the booster UAV comprises a second propulsor operatively coupled with the flight control system, wherein the method further comprises the step of controlling the second propulsor to produce a desired amount of thrust during descent.

In certain aspects, the propulsor employs jet propulsion or rocket propulsion and the second propulsor employs a motor-driven propeller.

In certain aspects, the trigger event occurs when either of the host aircraft or the booster UAV achieves a predetermined altitude.

In certain aspects, the predetermined altitude is a cruise altitude for the host aircraft.

In certain aspects, the host aircraft comprises a propulsor configured to operate at an altitude range that ranges from a minimum altitude to a maximum altitude.

In certain aspects, the predetermined altitude is the minimum altitude.

According to a third aspect, a booster aircraft system comprises: a host aircraft; and a booster unmanned aerial vehicle (UAV) removably coupled to said host aircraft, wherein the booster UAV is configured to: provide thrust to the host aircraft during takeoff and ascent of the host aircraft; release from the host aircraft upon a trigger event; and autonomously navigate to a predetermined location during descent.

In certain aspects, the booster UAV is reusable.

In certain aspects, the booster UAV is further configured to determine the level of thrust based on a signal from an onboard sensor from the host aircraft.

In certain aspects, the booster UAV comprises a jet propulsor.

In certain aspects, the booster UAV comprises a motor-driven propeller.

In certain aspects, the booster UAV comprises an engine-driven propeller.

In certain aspects, the booster UAV comprises a rocket engine.

In certain aspects, the booster aircraft system further comprises an aircraft coupling attached to an airframe of the booster UAV that is configured to removably couple with the host aircraft.

In certain aspects, the aircraft coupling comprises a pylon configured to engage a rail positioned on the host aircraft.

In certain aspects, the rail is positioned on a wing of the host aircraft.

In certain aspects, the booster UAV is configured to produce a desired amount of thrust during descent.

In certain aspects, the booster UAV is configured to glide to the predetermined location during descent without producing thrust.

In certain aspects, the booster UAV comprises a first propulsor to provide thrust to the host aircraft during takeoff and ascent of the host aircraft and a second propulsor to produce a desired amount of thrust during descent.

In certain aspects, the first propulsor employs a jet propulsion or rocket propulsion and the second propulsor employs a motor-driven propeller.

In certain aspects, the trigger event occurs when either of the host aircraft or the booster UAV achieves a predetermined altitude.

In certain aspects, the predetermined altitude is a cruise altitude for the host aircraft.

In certain aspects, the host aircraft comprises a propulsor configured to operate at an altitude range that ranges from a minimum altitude to a maximum altitude.

In certain aspects, the predetermined altitude is the minimum altitude.

In certain aspects, the host aircraft comprises an intelligence, surveillance, and reconnaissance (ISR) payload to collect data or monitor an area.

### DESCRIPTION OF THE DRAWINGS

These and other advantages of the present disclosure may be readily understood with the reference to the following specifications and attached drawings wherein:

FIG. 1a illustrates a host aircraft equipped with a set of booster UAVs during takeoff and climb.

FIG. 1b illustrates the host aircraft of FIG. 1a with the booster UAVs detached and enroute to a predetermined location, which is illustrated as the launch point.

FIG. 1c illustrates the host aircraft of FIG. 1a at cruise altitude.

FIG. 1d illustrates an enlarged view of the host aircraft of FIG. 1a with booster UAVs installed thereon.

FIG. 1e illustrates an enlarged view of the host aircraft of FIG. 1a with booster UAVs removed therefrom.

FIG. 2 illustrates an isometric view of an example booster UAV.

FIG. 3 illustrates a block diagram of an example flight control system for a booster UAV.

FIG. 4 illustrates an example method for providing supplemental thrust to a host aircraft using a booster UAV.

### DETAILED DESCRIPTION

Preferred embodiments of the present disclosure will be described hereinbelow with reference to the accompanying drawings. The components in the drawings are not necessarily drawn to scale, the emphasis instead being placed upon clearly illustrating the principles of the present embodiments. For instance, the size of an element may be exaggerated for clarity and convenience of description. Moreover, wherever possible, the same reference numbers are used throughout the drawings to refer to the same or like elements of an embodiment. In the following description, well-known functions or constructions are not described in detail because they may obscure the disclosure in unnecessary detail. No language in the specification should be construed as indicating any unclaimed element as essential to the practice of the embodiments.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “side,” “front,”, “frontal”, “back,” and the like, are words of convenience and are not to be construed as limiting terms. The various data values (e.g., voltages, seconds, etc.) provided herein may be substituted with one or more other predetermined data values and, therefore, should not be viewed limiting, but rather, exemplary. For this disclosure, the following terms and definitions shall apply:

The terms “aerial vehicle” and “aircraft” refer to a machine capable of flight, including, but not limited to, fixed wing aircraft, unmanned aerial vehicle, variable wing aircraft, and vertical take-off and landing (VTOL) aircraft.

The term “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The terms “circuits” and “circuitry” refer to physical electronic components (e.g., hardware) and any software and/or firmware (“code”) which may configure the hardware, be executed by the hardware, and or otherwise be associated with the hardware. As used herein, for example, a particular processor and memory may comprise a first “circuit” when executing a first set of one or more lines of code and may comprise a second “circuit” when executing a second set of one or more lines of code. As utilized herein, circuitry is “operable” to perform a function whenever the circuitry comprises the necessary hardware and code (if any is necessary) to perform the function, regardless of whether performance of the function is disabled, or not enabled (e.g., by a user-configurable setting, factory trim, etc.).

The terms “communicate” and “communicating” refer to (1) transmitting, or otherwise conveying, data from a source to a destination, and/or (2) delivering data to a communications medium, system, channel, network, device, wire, cable, fiber, circuit, and/or link to be conveyed to a destination.

The term “composite material” as used herein, refers to a material comprising an additive material and a matrix material. For example, a composite material may comprise a fibrous additive material (e.g., fiberglass, glass fiber (“GF”), carbon fiber (“CF”), aramid/para aramid synthetic fibers, etc.) and a matrix material (e.g., epoxies, polyimides, and alumina, including, without limitation, thermoplastic, polyester resin, polycarbonate thermoplastic, casting resin, polymer resin, acrylic, chemical resin). In certain aspects, the composite material may employ a metal, such as aluminum and titanium, to produce fiber metal laminate (FML) and glass laminate aluminum reinforced epoxy (GLARE). Further, composite materials may include hybrid composite materials, which are achieved via the addition of some complementary materials (e.g., two or more fiber materials) to the basic fiber/epoxy matrix.

The terms “coupled,” “coupled to,” and “coupled with” as used herein, each mean a relationship between or among two or more devices, apparatuses, files, circuits, elements, functions, operations, processes, programs, media, components, networks, systems, subsystems, and/or means, constituting any one or more of: (i) a connection, whether direct or through one or more other devices, apparatuses, files, circuits, elements, functions, operations, processes, programs, media, components, networks, systems, subsystems, or means; (ii) a communications relationship, whether direct or through one or more other devices, apparatuses, files, circuits, elements, functions, operations, processes, programs, media, components, networks, systems, subsystems, or means; and/or (iii) a functional relationship in which the operation of any one or more devices, apparatuses, files, circuits, elements, functions, operations, processes, programs, media, components, networks, systems, subsystems, or means depends, in whole or in part, on the operation of any one or more others thereof.

The term “data” as used herein means any indicia, signals, marks, symbols, domains, symbol sets, representations, and any other physical form or forms representing information, whether permanent or temporary, whether visible, audible, acoustic, electric, magnetic, electromagnetic, or otherwise manifested. The term “data” is used to represent predetermined information in one physical form, encompassing any and all representations of corresponding information in a different physical form or forms.

The term “database” as used herein means an organized body of related data, regardless of the manner in which the data or the organized body thereof is represented. For example, the organized body of related data may be in the form of one or more of a table, map, grid, packet, datagram, frame, file, email, message, document, report, list, or in any other form.

The term “exemplary” means “serving as an example, instance, or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage, or mode of operation.

The term “memory device” means computer hardware or circuitry to store information for use by a processor. The memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like.

The term “network” as used herein includes both networks and inter-networks of all kinds, including the Internet, and is not limited to any particular network or inter-network.

The term “processor” means processing devices, apparatuses, programs, circuits, components, systems, and subsystems, whether implemented in hardware, tangibly embodied software, or both, and whether or not it is programmable. The term “processor” includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC). The processor may be coupled to, or integrated with, a memory device.

It is desirable to provide higher thrust during the takeoff and climb phase of flight, while also reducing the size of an aircraft's propulsors. Therefore, to allow an aircraft to be optimally sized for a given operating condition, one or more booster UAVs may be used during flight phases where higher thrust is needed, e.g., during takeoff and climb of the host aircraft. Such booster UAVs may be configured to affix to a host aircraft's frame and/or wing to provide the supplemental (i.e., additional) thrust only when needed. When the supplemental thrust is no longer needed, i.e., the host aircraft attains a predetermined altitude and/or is ready to cruise, the booster UAVs may automatically detach from the airframe and/or wing of the host aircraft and autonomously return to a predetermined location 104 (e.g., a home base, launch point, or other location) via a gliding technique and/or via an onboard propulsion system. At the predetermined location 104, the booster UAVs may autonomously land to be refueled/charged and, if needed, used to launch another host vehicle.

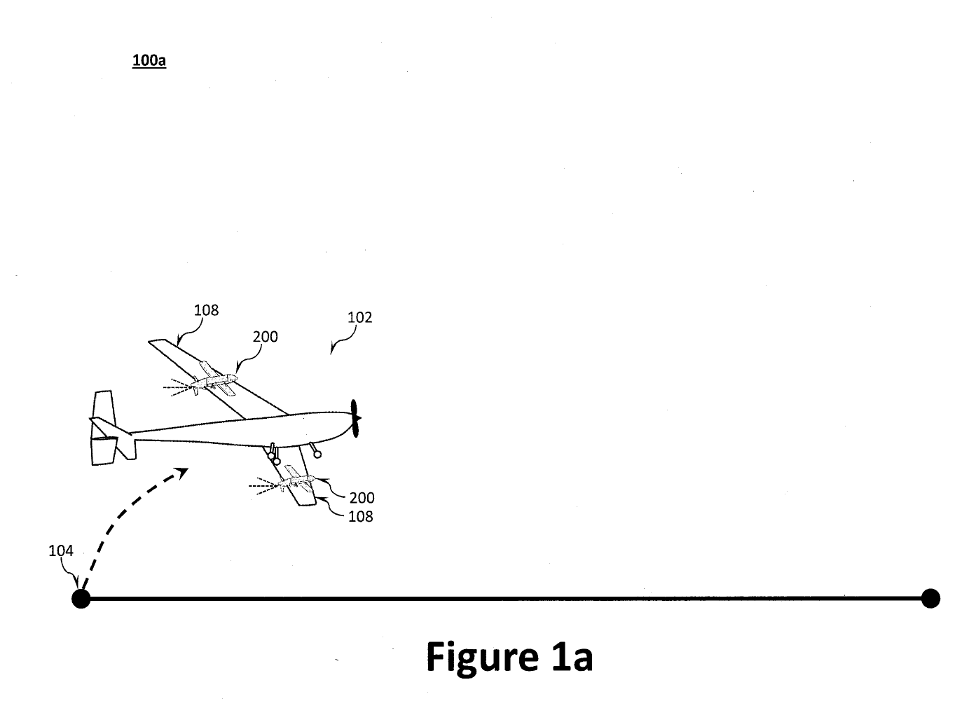

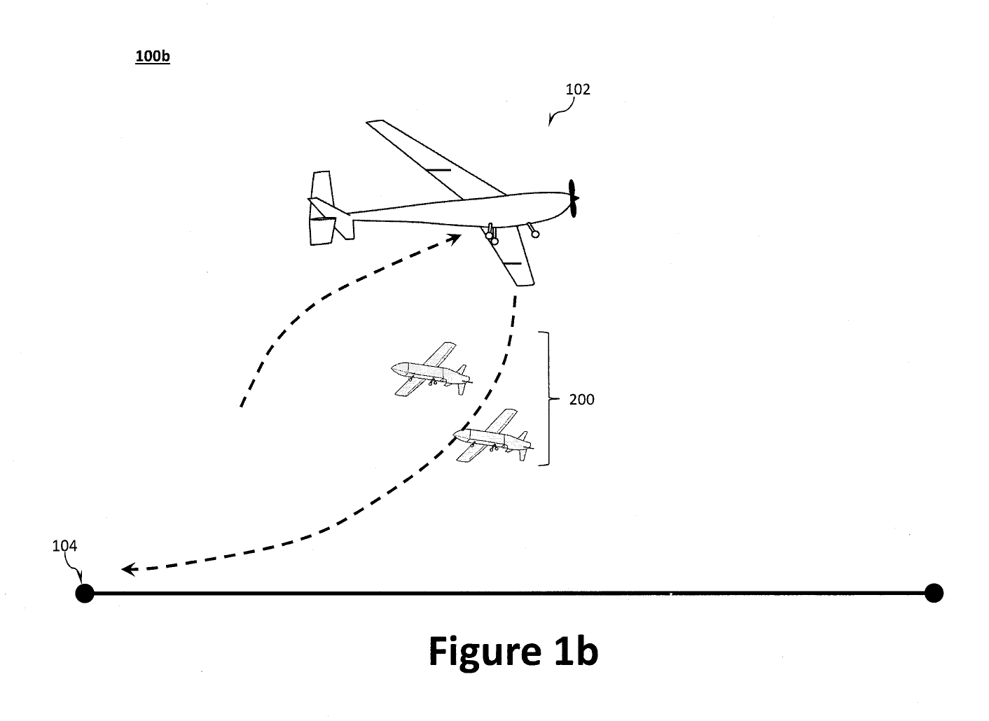

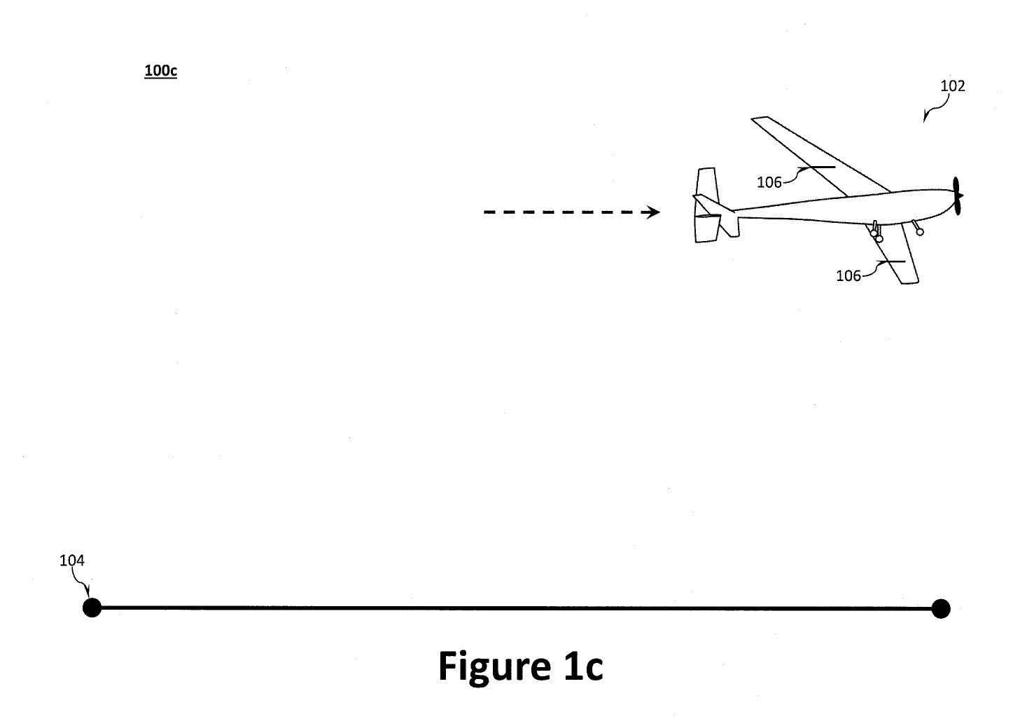

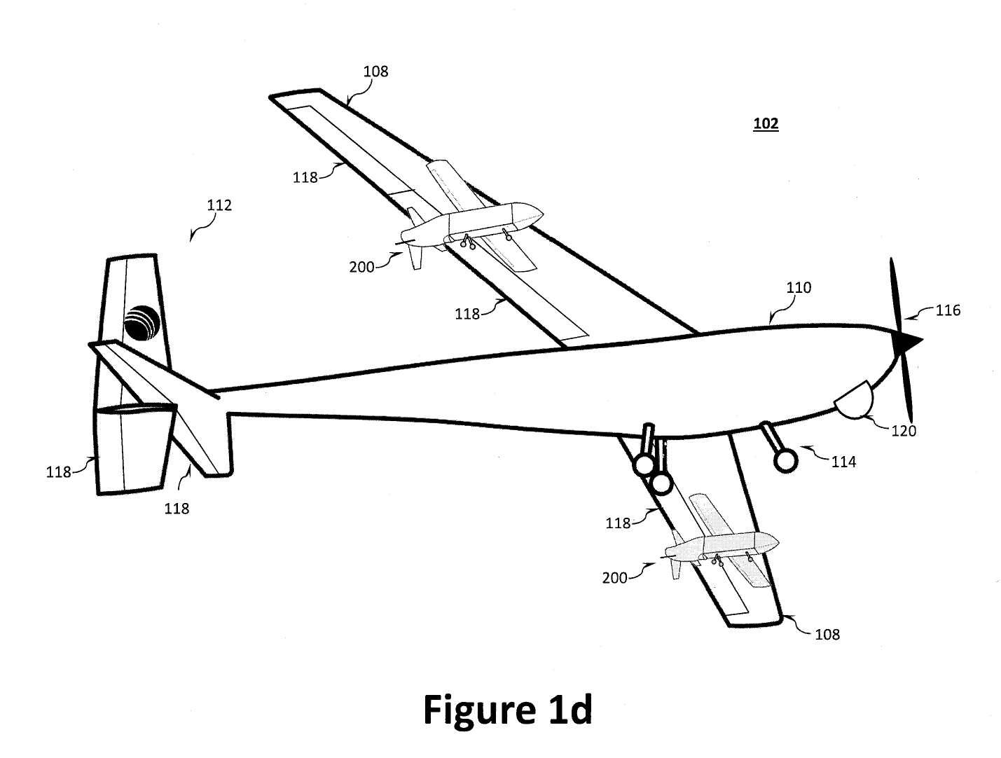

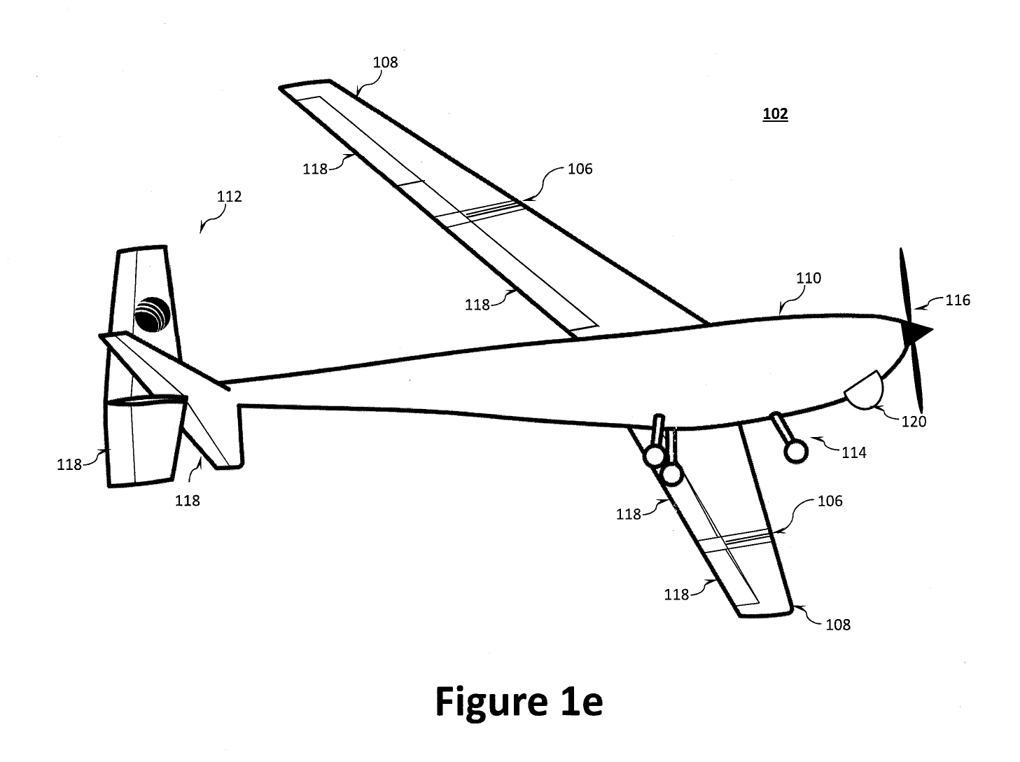

The booster aircraft system 100 (also referred to as 100a, 100b, 100c) of FIGS. 1a through 1c illustrates a scenario where a host aircraft 102 employs booster UAVs 200 to temporarily provide additional thrust. As illustrated, the booster aircraft system 100 employs a host aircraft 102 with two booster UAVs 200 coupled thereto at the underside of the host aircraft's 102 wings 108. Specifically, FIG. 1a illustrates a host aircraft 102 equipped with a set of booster UAVs 200 during takeoff and climb, while FIGS. 1b and 1c illustrate, respectively, the host aircraft 102 with the booster UAVs detached (and enroute to a predetermined location 104) and the host aircraft 102 at cruise altitude. FIG. 1d illustrates an enlarged view of the host aircraft 102 of FIG. 1a with booster UAV installed thereon, while FIG. 1e illustrates the host aircraft 102 with booster UAV removed therefrom. While two booster UAVs 200 are illustrated as coupled to the host aircraft 102 (e.g., one per wing 1008), fewer or additional booster UAVs 200 may be employed depending on the thrust requirements needed for the host aircraft 102 and the thrust provided by each booster UAV 200.

The booster aircraft system 100 can employ one or more booster UAVs 200, each of which may be a fixed wing vehicle with a high thrust-to-weight ratio and landing gear. In operation, the booster UAVs 200 provide additional thrust to the host aircraft 102. The host aircraft 102 may be a fixed wing aircraft having a fuselage 110, a wing 108 on each side of the fuselage 110 (defining a wing set), an empennage 112, landing gear 114, and one or more propulsors 116 (illustrated as a propeller, which may be driven by an engine or an electric motor). The wing 102 and empennage 112 may include at its trailing edges one or more moveable flight control surfaces 118, such as flaps, elevators, ailerons, rudders, and/or elevons. The host aircraft 102 may further comprise an intelligence, surveillance, and reconnaissance (ISR) payload 120 to collect data and/or monitor an area, an example of which is describe below in connection with the booster UAV 200. In other aspects, the host aircraft 102 may be used as a communications relay (e.g., to facilitate internet and/or cellular service on the ground in remote locations).

Each booster UAV 200 employs an attachment mechanism (e.g., an aircraft coupling 212, described below) that connects the booster UAV 200 to the host aircraft via a corresponding coupling 106 (e.g., a rack or rail) on the host aircraft 102. As illustrated, the booster UAVs 200 may be attached to the underside of the host aircraft's 102 wings 108, although other locations are contemplated. For example, the booster UAVs 200 may be attached to the upper side of the host aircraft's 102 wings 108, to the fuselage 110, empennage 112, etc. The attachment mechanism allows for the attachment of the booster UAV 200 to the host aircraft 102, and for subsequent detachment (release) from the host aircraft 102 at a set point on the loiter envelope or another trigger event. The set point may be based on (or triggered by), for example, a measured altitude, a received altitude, a command from pilot, or another metric/parameter.

The weight and drag penalty imposed on the host aircraft 102 through the attachment of the booster UAV 200 to the host aircraft 102 should be minimized. Therefore, to reduce weight of the host aircraft 102, the attachment mechanism may be configured such that the weight is entirely (or substantially) associated with the booster UAV 200. Indeed, upon release, the entire (or majority of) attachment mechanism departs with the booster UAV 200. In other words, the corresponding coupling 106 positioned on the wings 108 is preferably light weight and passive, thereby obviating the need for heavy actuators and the like. For example, unlike normal aircraft pylons that would be fixedly attached to the wing of the primary aircraft (here, the host aircraft 102), the pylon should instead be part of the booster UAV 200 (i.e., rather than remain with the host aircraft 102 upon release). While the booster UAVs 200 are illustrated as suspended from the wings 108, the booster UAVs 200 may, in certain aspects, reside within a recess defined by the host aircraft 102, thereby mitigating drag. In such an example, the booster UAV's 200 wings may fold or otherwise retract to allow for inserting into the recess, whereby the wings would automatically extend/unfold when detached from the host aircraft 102.

In certain aspects, the host aircraft 102 may have wings that comprise additional wing components, such as pylons and other control surfaces. These additional wing components may be necessary for the host aircraft 102 to operate at its designed flight envelope. The booster UAV 200 may be coupled to the host aircraft at the additional wing components. Such that, the weight of the host aircraft 102 is unaffected by an attachment mechanism for the booster UAV 200.

During operation, as best illustrated in FIG. 1a, the booster UAV(s) 200 provide supplemental thrust to the host aircraft 102 during the initial phase of flight, such as the takeoff and climb/ascent phases. Upon a trigger event, as best illustrated in FIG. 1b, the booster UAVs 200 can detach from the host aircraft 102. For example, the booster UAV 200 may be configured to disengage the aircraft coupling 212 in response to a signal from a flight controller (trigger event), thereby releasing the booster UAV 200 from the host aircraft 102. The trigger event may occur when either (or both) of the host aircraft 102 and/or the booster UAV 200 achieve a predetermined altitude (e.g., a cruising altitude or another desired altitude).

As can be appreciated, the booster UAVs 200 may also be used during the climb/ascent phase to propel the host aircraft 102 until it achieves a predetermined altitude (which can be a significant altitude) and/or speed. This allows for further reduction in the required propulsor size of the host aircraft 102, therefore cruise specific fuel consumption (SFC) is optimized. By way of illustration, for medium-altitude aircraft (such as the Orion UAV, available from Aurora Flight Sciences Corporation), the booster UAVs 200 may be used to propel the aircraft until it achieves its cruise altitude (e.g., about 15,000-30,000 feet), at which point the booster UAVs 200 release from the host aircraft 102 and the host aircraft 102 is self-sustained. Therefore, the host aircraft 102 can be optimized for its cruise altitude where the booster UAVs 200 propel the host aircraft 102 to the cruise altitude.

The booster UAVs 200, however, are advantageous even when they cannot reach the cruise altitude of the host aircraft 102. Indeed, for a high-altitude host aircraft (e.g., those with a cruise altitude over 40,000 feet, for example, in the range of 40,000-70,000 feet), the booster UAVs 200 may be configured to release before achieving the cruising altitude of the host aircraft 102, but at a sufficiently high altitude such that the host aircraft 102 is self-sustained (i.e., remains airborne under its own power). By way of illustration, a host aircraft 102 may be configured with a propulsor 116 that has been designed (or otherwise optimized) to operate at its cruise altitude range. In this scenario, the propulsor 116 may not be sufficient to launch or to maintain the host aircraft 102 airborne at lower altitudes. Rather, the propulsor 116 may be able to sustain the host aircraft 102 in flight throughout an operable altitude range, which could range from a minimum altitude (first altitude) to a maximum altitude (second altitude), which would encompass the cruise altitude range. In this case, the booster UAV 200 could provide additional thrust to the host aircraft 102 until the host aircraft 102 achieves the lower end of the operable altitude range (i.e., a minimum altitude needed for sustain flight) before the booster UAV releases itself from the host aircraft 102. The host aircraft 102 may then propel itself from the minimum altitude to its desired cruise altitude (or altitude range) for which the host aircraft 102 was designed or optimized. In other words, another advantage of the disclosed booster UAV 200 is that it can provide additional thrust or help maintain the thrust level to the host aircraft 102 until it achieves an altitude sufficient for its propulsors 116 to sustain forward flight. Therefore, while existing aircraft are typically designed to support the full phase of flight at the expense of efficiency, the disclosed booster UAV 200 permit optimization of engine-propeller selection for the host aircraft 102 at its cruise altitude without concerns regarding sustainability of the engine-propeller selection during takeoff and/or lower altitude flight.

Once the booster UAVs are released from the host aircraft 102, the booster UAVs 200 may autonomously fly (using generated thrust) or glide (without generating thrust) back to the predetermined location 104. In certain aspects, the host aircraft 102 may perform a spiral climb from the launching point at the predetermined location 104 so that the host aircraft 102 remains near (but higher above) the launch site at the time of release. In this case, the booster UAV 200 may more easily glide back to the predetermined location 104. In a glide scenario, the booster UAV 200 may shut off the propulsor(s) 208 or place the propulsor(s) 208 into an idle mode (or shut off the propulsor(s) 208). Alternatively, the booster UAV 200 may throttle/control the propulsor 208 via its flight controller to provide a desired amount of thrust during descent. In another alternative, the booster UAV may have a secondary propulsion system (e.g., a second propulsor 208) for use during descent and/or a missed-approach maneuver (e.g., after a landing abort).

The booster UAV 200 may employ one or more visual or electronic markers at the predetermined location 104 to assist in navigating the booster UAV 200 to the predetermined location 104. In one aspect, the one or more markers may be passive markers positioned on the ground that can be tracked by the booster UAV using one or more optical sensors (e.g., cameras, LIDAR, electro-optical sensors, etc.). The passive markers may be provided as one or more predetermined shapes painted onto a surface (e.g., the runway) or one or more reflectors, such as an infrared (IR) reflectors (e.g., retro-reflective tape), that may be tracked by the booster UAV's 200 onboard sensor suite. In another aspect, the markers may be active. For example, an active IR illuminator may be positioned at the predetermined location 104 to assist in tracking. Upon recognition of the beacons, booster UAV 200 may rely on a vision-based tracking routine. Specifically, heading and altitude commands may track the location of the one or more markers to the center of the field of view. In another example, information (e.g., positional data) may be relayed from the predetermined location 104 to the booster UAV 200 during descent using, for example, radio frequency communication.

At the predetermined location 104, the booster UAVs 200 may be refueled/charged by ground personally (or automatically via a charging/refueling station) and, if needed, used to launch another host vehicle 102. Once at a cruising altitude, as best illustrated in FIG. 1c, the host aircraft 102 may then complete its flight plan free from the weight of the booster UAVs 200.

An advantage of the booster UAVs 200 is that they may be used to launch countless existing larger host aircraft 102, thereby mitigating costs down while still enabling high-reusability. That is, since each booster UAV 200 would only be operating its engine for the duration of the launch and ascent (e.g., 10-20 minutes), the flight time of the booster UAV 200 would be relatively nominal, and could therefore be used to launch 3 to 6 host aircraft 102 per hour. For example, on the ground, the booster UAV 200 may be recharged or refueled. The benefits of this approach include dramatically reduced engine weight, fuel consumption, and hence total vehicle size of the host aircraft 102. While the booster UAVs 200 is contemplated to be multi-use (i.e., reusable), single use variants are contemplated. For example, a rocket-based booster UAV 200 may employ a propellant (whether solid or liquid) that is single use. Therefore, upon return to the predetermined location 104, the booster UAV 200 may be discarded or, in certain aspects, rebuilt (e.g., the propulsor may be replaced).

The use of booster UAVs 200 allows for a host aircraft 102 that is more appropriately sized for the cruise phase of flight which will result in lighter and cheaper aircraft. With nominal modification to the host aircraft 102, an attachment methodology for these booster vehicles can be designed to allow the host aircraft to operate outside its own propulsion system's limitations—whether it is for supplemental thrust during takeoff and climb to reduce takeoff distance, or to lift more weight to altitude than the onboard thrust allows.

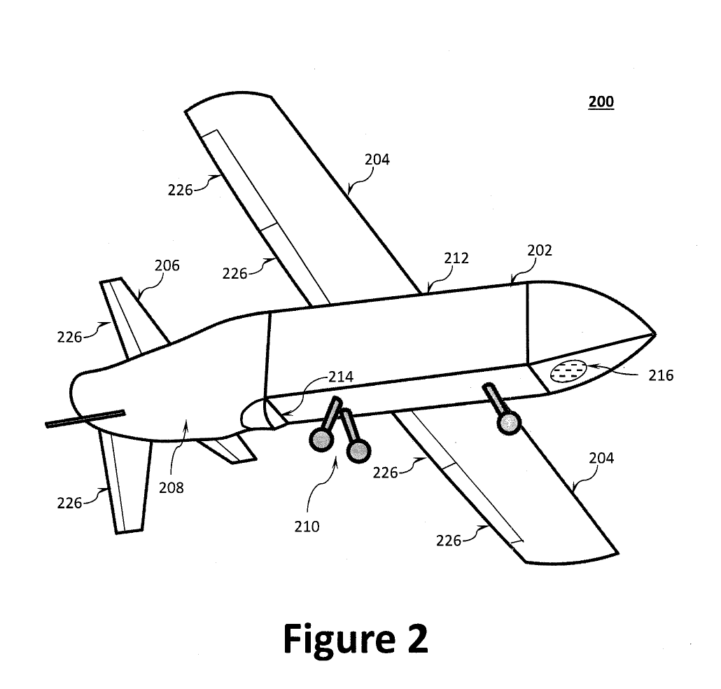

FIG. 2 illustrates an isometric view of an example booster UAV 200, which generally comprises an airframe 202 (e.g., a fuselage), a wing 204 on each side of the airframe 202 (together defining a wing set), one or more propulsors 208, and an empennage 206. The booster UAV 200 further includes an aircraft coupling 212 to removably attach the booster UAV 200 to the host aircraft 102 at its corresponding coupling 106. The booster UAV 200 may further include landing gear 210 to facilitate an autonomous landing at a predetermined location 104, so that the booster UAV 200 can be reused for the next flight.

In operation, the booster UAVs 200 may attach to the fixed-wing host aircraft 102 via an aircraft coupling 212 to boost the thrust of the host aircraft 102 when necessary. When no longer needed, the booster UAVs 200 may detach from the host aircraft 102, thus removing their weight from the aircraft when they are no longer needed. The booster UAVs 200 may autonomously return to the predetermined location 104 or another operating point for refueling and reuse. Indeed, an advantage of the disclosed booster aircraft system 100 (and of the booster UAV 200) is that the booster is a complete, autonomous UAV that can autonomously navigate/fly itself back to the predetermined location 104 (e.g., the takeoff location).

The booster UAV 200 may be configured as a fixed-wing UAV with a very high thrust-to-weight ratio. The thrust-to-weight ratio of the propulsor 208 may be, for example, 4.6:1. To reduce weight, the booster UAVs 200 may be fabricated from a composite material, such as carbon fiber, which reduces weight while ensuring durability. The booster UAV 200 may be configured such that its wing 204, as well as the mounting of the booster UAV 200 to the host aircraft 102, are designed to generate lift to reduce the structural loads imposed on the host aircraft 102 due to the mass of the booster UAV 200. In certain aspects, the booster UAV 200 may be configured to increase the overall lift by generating more lift than the weight penalty it imposes. For example, the wings 204 may be sized and shaped to compensate for the added wing loads imparted by the attachment of the booster UAV 200 to the host aircraft's 102 wing 108. Depending on the application, the wings 204 may be straight, swept-back, or swept-forward. In other aspects, the wings 204 may be folded or retracted when mounted to the host aircraft 102. For example, the wings 204 may retract backward (toward the empennage 206) such that its span-wise length generally aligns with the longitudinal length of the airframe 202 (e.g., they may be parallel).

The empennage 206 may comprise a plurality of stabilizers (e.g., vertical, horizontal, angled, etc.). As illustrated, for example, a first set of stabilizes may be configured with an anhedral angle (i.e., a downward angle from horizontal, defining a ∧-tail), while a second set of stabilizes may be configured with a dihedral angle (i.e., an upward angle from horizontal, defining a V-tail (or “vee-tail”)); thereby collectively generally defining an x-tail configuration. However, other empennage designs are contemplated. For example, in certain aspects, a set of vertical stabilizers may be positioned substantially perpendicular to a horizontal stabilizer to define a twin tail (H-tail arrangement or U-tail arrangement) empennage. The wing 204 and empennage 206 may include at its trailing edges one or more moveable flight control surfaces 226, such as flaps, elevators, ailerons, rudders, and/or elevons.

The booster UAVs 200 may be, for example, small, jet-powered mini-UAVs that removable couple to the host aircraft 102. In certain aspects, however, the booster UAVs 200 may be propeller-driven or rocket-driven. Therefore, the propulsor(s) 208 may include jet propulsion technology (e.g., turbo jet, turbo fan, etc.), engine/motor-driven propellers, rocket engines, etc. In certain aspects, electric- and/or hybrid-powered propulsors 208 may be used. In other aspects, rocket propellant may be used during launch, whereby the booster UAV 200 may glide or use electric motors/propellers to return to the predetermined location 104 (e.g., using power stored to an onboard battery). For example, the propulsor 208 may be a small twin-spool, axial, counter-rotating turbofan engine that outputs, for example, 2.7 kilonewtons (610 lbf) to 3.1 kilonewtons (700 lbf). Air flow into the propulsor 208 may be provided via a forward-facing air inlet 214 positioned on the underside of the fuselage 202 to facilitate unobstructed access when mounted to the host aircraft 102.

The size and location of the propulsors 208 may be optimized for a particular need. Therefore, while the booster UAV 200 is illustrated as having only one propulsor 208, a person of skill in the art would understand that greater, or fewer, propulsors 208 may be employed depending on, for example, thrust requirements. Further, the booster UAV 200 may employ two or more types of propulsors 208. For example, a first propulsor 208 may be used to thrust the booster UAV 200 during takeoff and ascent (e.g., when coupled to the host aircraft 102), while a second propulsor 208 may be used to provide thrust to the booster UAV 200 during the return flight to the predetermined location 104. In this example, the first propulsor 208 may be a higher-power thruster (e.g., rockets, jet engines, etc.), while the second propulsor 208 may be a lower-power thruster (e.g., propeller/rotor driven).

The booster UAV's 200 landing gear 210 is illustrated in a tricycle arrangement having a set of main wheels and a single forward wheel, although a taildragger arrangement is also contemplated. While wheels are contemplated, other types ground contact components are also contemplated depending on the terrain, including skis (or wheel-skis) for snow, floats for water, and combinations thereof. The landing gear 210 may employ an arched landing gear formed from spring steel, which is sometime called spring steel landing gear. The spring steel landing gear may be fabricated as from a steel tube, a spring steel bar, etc. An advantage of spring steel landing gear is that no other shock-absorbing device is needed, thereby reducing weight and cost; the deflecting leaf provides the shock absorption. Instead of steel, the landing gear structure may be fabricated from one of more composite materials, including carbon fiber tubes, rods, sheets, etc. Where desired, the landing gear 210 may further employ air and/or oil type landing gear struts to absorb shock during taxiing and landing. In certain aspects, the shock absorption capability of the main landing gear may be enhanced through trailing-link enhancements. For example, the main landing gear may include a trailing-link suspension with or more links connected between, and perpendicular to and forward of, the axle and a pivot point.

The aircraft coupling 212 may be attached to a hardpoint (i.e., a location on an airframe configured to carry an external or internal load) of the topside of the booster UAV 200 and configured to engage a corresponding coupling 106 positioned on the host aircraft 102, which may likewise be positioned at a hardpoint of the host aircraft's 102 underside. For example, the aircraft coupling 212 may couple to a station provided on the host aircraft 102 configured to support and mount the booster UAV 200. Each station may include, for example, a pylon and rack, where the booster UAV's 200 aircraft coupling 212 comprises the pylon that couples to the rack via a rail to guide the booster UAV 200 during attachment and detachment.

A payload bay or avionics bay 216 may be provided on (or in) the airframe 202 to house the various navigation and flight control systems of the booster UAV 200, such as the flight control system 300. The flight control system 300, as will be discussed, may be configured to control the various aircraft components and functions. For example, the navigation and flight control systems may be communicatively coupled with an inertial navigation system (INS) 218b that is communicatively coupled with an inertial measurement unit (IMU) 218c and global positioning system (GPS) 218a, an onboard data storage device 220 (e.g., hard drive, flash memory, or the like), a wireless communication device (e.g., a wireless transceiver 222 and antenna 224), or virtually any other desired services. The GPS gives an absolute drift-free position value that can be used to reset the INS solution or can be blended with it by use of a mathematical algorithm, such as a Kalman Filter. Any information, including any video or other data collected by the booster UAV 200, may be communicated to a ground control station in real time wirelessly. The booster UAV 200 may be further equipped to store said video and data to the onboard data storage device.

In certain aspects, each booster UAV 200 may include one or more onboard sensors that enable a first booster UAV 200 to coordinate with a second booster UAV 200, or to otherwise gather data. For example, the booster UAV 200 may be configured to detach from the host aircraft 102 and to perform swarm operations.

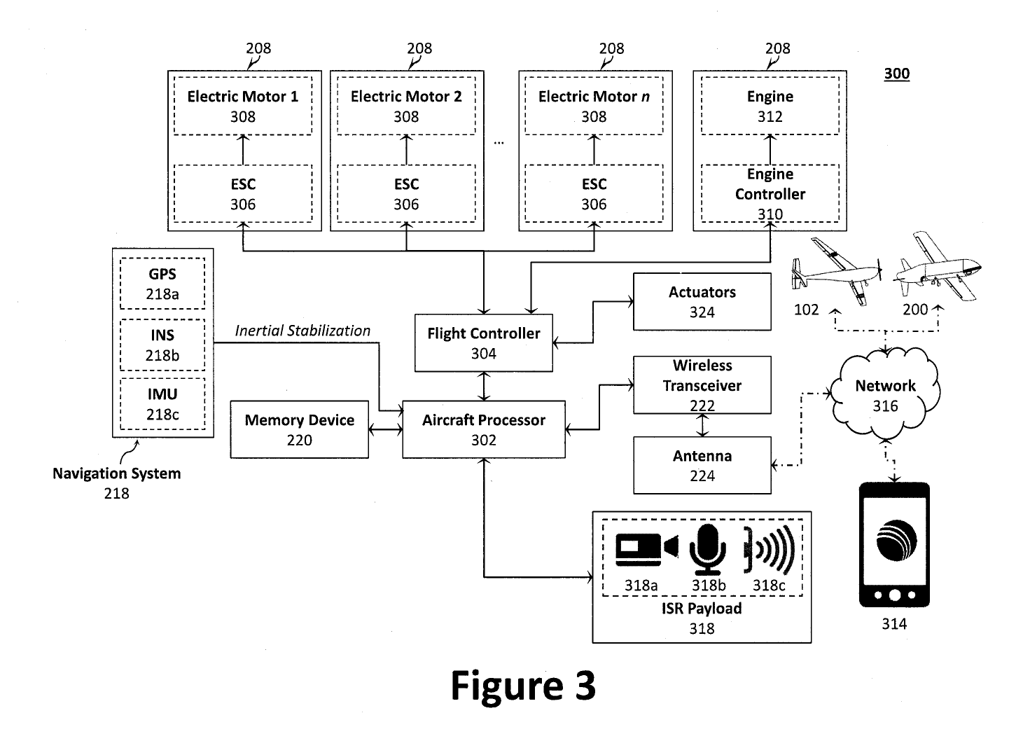

FIG. 3 illustrates a block diagram of an example flight control system 300 for the booster UAV 200. While the flight control system 300 is described in connection with the booster UAV 200, it should be appreciated that the host aircraft 102 may employ a similar flight control system 300. The flight control system 300 may be configured to control the various aircraft components and functions of the booster UAV 200. As illustrated, the flight control system 300 includes one or more aircraft processors 302 communicatively coupled with at least one memory device 220, a flight controller 304, a wireless transceiver 222, and a navigation system 218. The aircraft processor 302 may be configured to perform one or more operations based at least in part on instructions (e.g., software) and one or more databases stored to the memory device 220 (e.g., hard drive, flash memory, or the like).

The aircraft control system may further include other desired services, such as a wireless transceiver 222 coupled with an antenna 224 to communicate data between the flight control system 300 and a remote device 314 (e.g., portable electronic devices, such as smartphones, tablets, and laptop computers) or other controller (e.g., at a base station, such as the predetermined location 104). The flight control system 300 may also communicate with the host aircraft 102 or another booster UAV 200 via the wireless transceiver 222. In certain aspects, the booster UAV 200 may communicate with the host aircraft 102 via a wired connection. For example, the attachment mechanism between the booster UAV 200 and the host aircraft 102 may include one of more electrical contacts to allow for communication therebetween. The wired connection may be used to communicate data before release of the booster UAV 200 and/or to trigger release of the booster UAV 200 from the host aircraft 102 at the set point/upon a trigger event.

In certain aspects, the flight control system 300 may communicate data (processed data, unprocessed data, etc.) with the remote device 314, the host aircraft 102, and/or another booster UAV 200 over a network 316. In certain aspects, the wireless transceiver 222 may be configured to communicate using one or more wireless standards such as Bluetooth (e.g., short-wavelength, Ultra-High Frequency (UHF) radio waves in the Industrial, Scientific, and Medical (ISM) band from 2.4 to 2.485 GHz), near-field communication (NFC), Wi-Fi (e.g., Institute of Electrical and Electronics Engineers' (IEEE) 802.11 standards), etc. The remote device 314 may facilitate monitoring and/or control of the flight control system 300 and its payload(s), including an ISR payload 318.

The aircraft processor 302 may be operatively coupled to the flight controller 304 to control operation of the various actuators 324 (e.g., those to control movement and locking of any flight surfaces, such as the moveable flight control surfaces 118, and to engage/disengage the aircraft coupling 212), electric motor 308 (e.g., via an electronic speed controller (ESC) 306), and/or engines 312 (e.g., via an engine controller 310) in response to commands from an operator, autopilot, a navigation system 218, or other high-level system via the wireless transceiver 222. In certain aspects, the aircraft processor 302 and the flight controller 304 may be integrated into a single component or circuit. In operation, the flight controller 304 may dynamically (i.e., in real-time or near real-time) and independently adjust thrust during the various stages of flight (e.g., take-off, return to base, and landing) via the ESC 306 or engine controller 310 (as the case may be) to control roll, pitch, or yaw of the booster UAV 200. When rotors with rotor blades (e.g., propellers) are used, the flight controller 304 may vary the revolutions per minute (RPM) of the rotor and/or, where desired, vary the pitch of the rotor blades. For example, the electric motors 308 may be controlled by adjusting power supplied to each electric motor from a power supply (e.g., a battery pack or a battery bank) via the ESC 306.

The aircraft processor 302 may be operatively coupled to the navigation system 218, which may include the GPS 218a that is communicatively coupled with the INS 218b and/or the IMU 218c, which can include one or more gyros and accelerometers. The GPS 218a gives an absolute drift-free position value that can be used to reset the INS solution or can be blended with it by use of a mathematical algorithm, such as a Kalman Filter. The navigation system 218 may communicate, inter alia, inertial stabilization data to the aircraft processor 302.

To collect data and/or monitor an area, the flight control system 300 may further be equipped with an ISR payload 318 comprising, for example, one or more cameras 318a (e.g., an optical instrument for recording or capturing images and/or video, including light detection and ranging (LIDAR) devices), audio devices 318b (e.g., microphones, echolocation sensors, etc.), and other sensors 318c to facilitated ISR functionality and provide ISR data (e.g. photographs, video, audio, sensor measurements, etc.). The ISR payload 318 is operatively coupled to the aircraft processor 302 to facilitate communication of the ISR data between the ISR payload 318 and the aircraft processor 302. The ISR data may be used to navigate the booster UAV 200 and/or otherwise control the flight control system 300. In certain aspects, the ISR payload 318 may be rotatably and pivotally coupled to, for example, the underside surface of the airframe 202 (or another structural component, such as the wings 204) via a gimbal system to enable the ISR payload 318 to be more easily oriented downward to monitor objects below and/or on the ground. The data may be dynamically or periodically communicated from the flight control system 300 to the remote device 314 over the network 316 via the wireless transceiver 222, or stored to the memory device 220 for later access or processing.

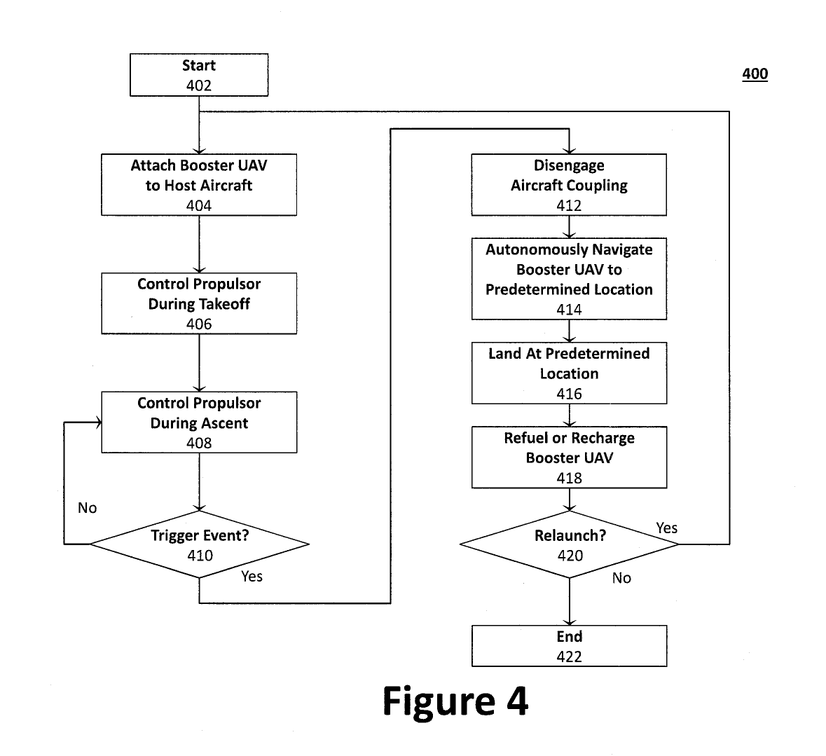

FIG. 4 illustrates an example method 400 for providing supplemental thrust to a host aircraft 102 using a booster UAV 200, which starts at step 402. At step 404, the booster UAV 200 is attached to a host aircraft 102 via an aircraft coupling 212. The aircraft coupling 212 is attached to the airframe 202 of the booster UAV 200 and is configured to removably couple with the host aircraft 102. At steps 406 and 408, the flight control system 300 controls one or more (or all) of the propulsors 208 of the booster UAV 200 dynamically (e.g., in real-time or near real-time) to provide supplemental thrust to the host aircraft 102 during takeoff and ascent of the host aircraft 102.

At step 410, the flight control system 300 determines whether a trigger event has occurred. The trigger event may be deemed to have occurred, for example, when either of the host aircraft 102 or the booster UAV 200 achieves a predetermined altitude based on a signal from an onboard sensor or from that of the host aircraft 102. That is, the flight control system 300 is communicatively coupled (in communication) with an onboard sensor of the host aircraft 102. For example, the host aircraft 102 may communicate sensor readings (via its onboard sensors) to the booster UAV 200 (via wireless transceiver 222 or via a wired link), which may be used to, for example trigger release of the booster UAV 200 from the host aircraft 102 and/or to throttle the thrust of the booster UAV 200 to achieve a desired power requirement, speed, etc. The predetermined altitude may be a cruise altitude for the host aircraft 102. In certain aspects, the host aircraft 102 may comprises a propulsor 116 that is configured to operate at an altitude range (e.g., an operable altitude range) that ranges from a minimum altitude to a maximum altitude, where the predetermined altitude is the minimum altitude (i.e., the minimum altitude require for the host aircraft 102 to propel itself). If the trigger event has occurred, the process proceeds to step 412, otherwise the process returns to step 408. At step 412, the flight control system 300 sends a signal to disengage the aircraft coupling 212 to release the booster UAV 200 from the host aircraft 102.

At step 414, the flight control system 300 autonomously navigates the booster UAV 200 to a predetermined location 104 during descent by controlling operation of the various actuators 324 and/or moveable flight control surfaces 118, which may be controlled based at least in part on information collected by one or more onboard sensors (e.g., those provided by an ISR payload 318).

At step 416, the flight control system 300 autonomously lands the booster UAV 200 at the predetermined location 104. The predetermined location 104 may be identified using, for example, one or more markers at (or on) the ground and/or other positional information (e.g., GPS coordinates). At step 418, where the booster UAV 200 is reusable, the booster UAV 200 may be refueled or recharged (as the case may be) by, for example, ground personnel or through an automated process.

At step 420, it is determined whether the booster UAV 200 will be used to launch another host aircraft 102. As noted above, the booster UAV 200 may be used for multiple launches per day. If another launch is desired, the process returns to step 404 for a different host aircraft 102; otherwise the process ends at step 422 (e.g., the booster UAV 200 is shut off and stored until the next launch).

The above-cited patents and patent publications are hereby incorporated by reference in their entirety. Where a definition or the usage of a term in a reference that is incorporated by reference herein is inconsistent or contrary to the definition or understanding of that term as provided herein, the meaning of the term provided herein governs and the definition of that term in the reference does not necessarily apply. Although various embodiments have been described with reference to a particular arrangement of parts, features, and the like, these are not intended to exhaust all possible arrangements or features, and indeed many other embodiments, modifications, and variations will be ascertainable to those of skill in the art. Thus, it is to be understood that the teachings of the subject disclosure may therefore be practiced otherwise than as specifically described above.

What is claimed is:

1. A booster unmanned aerial vehicle (UAV) configured to provide supplemental thrust to a host aircraft, the booster UAV comprising:
a propulsor;
an airframe having at least one wing with a moveable flight control surface;
an aircraft coupling attached to the airframe and configured to removably couple with the host aircraft; and
a flight control system operatively coupled with the propulsor, the aircraft coupling and the moveable flight control surface, the flight control system being configured to autonomously navigate the booster UAV, wherein the flight control system is configured to:
control the propulsor to provide supplemental thrust to the host aircraft during takeoff and ascent of the host aircraft;
disengage the aircraft coupling to release the booster UAV from the host aircraft upon a trigger event; and
control the moveable flight control surface to autonomously navigate the booster UAV to a predetermined location during descent.

2. The booster UAV of claim 1, wherein the booster UAV is reusable.

3. The booster UAV of claim 1, wherein the flight control system is in communication with an onboard sensor from the host aircraft.

4. The booster UAV of claim 1, wherein the aircraft coupling comprises a pylon configured to engage a rail positioned on the host aircraft.

5. The booster UAV of claim 1, wherein the flight control system is configured to control the propulsor to produce a desired amount of thrust during descent.

6. The booster UAV of claim 1, wherein the booster UAV is configured to glide to the predetermined location during descent.

7. The booster UAV of claim 6, wherein the flight control system is configured to idle the propulsor during descent.

8. The booster UAV of claim 1, further comprising a second propulsor operatively coupled with the flight control system, wherein the flight control system is configured to control the second propulsor to produce a desired amount of thrust during descent.

9. The booster UAV of claim 1, wherein the trigger event occurs when either of the host aircraft or the booster UAV achieves a predetermined altitude.

10. The booster UAV of claim 9, wherein the host aircraft comprises a propulsor configured to operate at an altitude range that ranges from a minimum altitude to a maximum altitude.

11. A method for providing supplemental thrust to a host aircraft using a booster unmanned aerial vehicle (UAV), the method comprising:
attaching the booster UAV to a host aircraft via an aircraft coupling, wherein the aircraft coupling is attached to an airframe of the booster UAV and is configured to removably couple with the host aircraft;
controlling, via a flight control system, a propulsor of the booster UAV to provide supplemental thrust to the host aircraft during takeoff and ascent of the host aircraft;
disengaging the aircraft coupling to release the booster UAV from the host aircraft upon a trigger event; and
autonomously navigating, via a flight control system, the booster UAV to a predetermined location during descent.

12. The method of claim 11, wherein the booster UAV is reusable.

13. The method of claim 11, wherein the aircraft coupling comprises a pylon configured to engage a rail positioned on the host aircraft.

14. The method of claim 11, further comprising the step of controlling the propulsor to produce a desired amount of thrust during descent.

15. The method of claim 14, wherein the step of controlling the propulsor further comprises:
receiving, with the flight control system, an onboard sensor input from the host aircraft; and
controlling the propulsor based on the onboard sensor input.

16. The method of claim 11, wherein the booster UAV is configured to glide to the predetermined location during descent.

17. The method of claim 15, further comprising the step of disabling idling the propulsor during descent.

18. The method of claim 11, wherein the booster UAV comprises a second propulsor operatively coupled with the flight control system, wherein the method further comprises the step of controlling the second propulsor to produce a desired amount of thrust during descent.

19. The method of claim 11, wherein the trigger event occurs when either of the host aircraft or the booster UAV achieves a predetermined altitude.

20. The method of claim 19, wherein the host aircraft comprises a propulsor configured to operate at an altitude range that ranges from a minimum altitude to a maximum altitude.
